(19) United States
(12) Patent Application Publication
(10) Pub. No.: US 2017/0276202 A1
(43) Pub. Date: Sep. 28, 2017

(54) Dampener Assembly

(71) Applicant: BASF SE, Ludwigshafen (DE)

(72) Inventor: Frank Friedrich, Ann Arbor, MI (US)

(21) Appl. No.: 15/512,090

(22) PCT Filed: Sep. 24, 2015
(86) PCT No.: PCT/US2015/051987

§ 371 Date: Mar. 17, 2017

Related U.S. Application Data
(60) Provisional application No. 62/054,795, filed on Sep. 24, 2014.

(51) Int. Cl. F16F 1/373; B60G 15/06

(52) U.S. Cl. CPC F16F 1/373; B60G 15/06; F16F 1/37

(57) ABSTRACT

A dampener assembly dampens vibrations between a first member and a second member. The bumper comprises a cellular material defining a plurality of cells. The bumper has a mounting surface wherein a portion of the plurality of cells are open at the mounting surface. The dampener assembly also includes an overmolded bracket comprising a polymeric material. The overmolded bracket has a body portion extending between a first bracket end and a second bracket end. The body portion has an attachment surface configured to couple to the first member. The body portion also has a bonding surface opposite the attachment surface with the bonding surface coupled to the bumper. The polymeric material of the overmolded bracket is disposed within the open cells at the mounting surface of the bumper for bonding the overmolded bracket and the bumper to one another.

### CROSS-REFERENCE TO RELATED APPLICATIONS

The subject patent application claims priority to and all the benefits of U.S. Provisional Patent Application No. 62/054,795 which was filed on Sep. 24, 2014, which is herein incorporated by reference in its entirety.

### BACKGROUND

1. Field of the Invention

The present invention generally relates to a dampener assembly for use in a vehicle.

2. Description of the Related Art

Generally, components within a vehicle are subject to vibrations and sudden movements during normal operation of the vehicle. For example, the vehicle may be subject to vibrations from traveling on the ground or from moving members within the vehicle when in the air. When the vehicle is in the air, such as an aircraft or helicopter, vibrations propagate throughout the aircraft or helicopter, typically from the engine, such as a jet engine, propeller, or helicopter rotor. As such, there is a need to develop a dampener assembly for use in various vehicles to help reduce or even eliminate the effect of vibrations on selected components within the vehicle. Further, there is a need to develop a light weight dampener assembly, especially when the dampener assembly is used in an aircraft or helicopter.

### SUMMARY OF THE INVENTION AND ADVANTAGES

A dampener assembly dampens vibrations between a first member and a second member with at least one of the first and second members movable relative to the other one of the first and second members. The dampener assembly includes a bumper that comprises a cellular material defining a plurality of cells. The bumper has a mounting surface wherein a portion of the plurality of cells are open at the mounting surface. The dampener assembly also includes an overmolded bracket comprising a polymeric material. The overmolded bracket has a body portion extending between a first bracket end and a second bracket end. The body portion has an attachment surface configured to couple to the first member. The body portion also has a bonding surface opposite the attachment surface with the bonding surface coupled to the bumper. The polymeric material of the overmolded bracket is disposed within the open cells at the mounting surface of the bumper for bonding the overmolded bracket and the bumper to one another.

Accordingly, the dampener assembly is able to dampen vibrations between a first member and a second member. Furthermore, the dampener assembly is a lighter than a standard dampener assembly, which is advantageous when the dampener assembly is used in vehicles, including aircrafts or helicopters.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental view of a fuel cell having an outer casing and an isolation floor with at least one dampener assembly disposed between the outer casing and the isolation floor;

FIG. 2 is a top perspective view of a first embodiment of an overmolded bracket and a first embodiment of a bumper of the dampener assembly of FIG. 1;

FIG. 3 is an exploded view of the dampener assembly of FIG. 2;

FIG. 4 is a top view of the dampener assembly of FIG. 2;

FIG. 5 is a bottom view of the dampener assembly of FIG. 2;

FIG. 6 is a side view of the dampener assembly of FIG. 2;

FIG. 7 is a front view of the dampener assembly of FIG. 2;

FIG. 8 is a front cross-sectional view of the dampener assembly along line 8-8 of FIG. 6;

FIG. 9 is a side cross-sectional view of a first embodiment of the dampener assembly along line 9-9 of FIG. 4;

FIG. 10 is a side cross-sectional view of the dampener assembly including inserts disposed within apertures defined by the overmolded bracket;

FIG. 11 is a side cross-sectional view of a second embodiment of the overmolded bracket of the dampener assembly;

FIG. 12 a side cross-sectional view of a third embodiment of the overmolded bracket of the dampener assembly;

FIG. 13 is a side cross-sectional view of a portion of the dampener assembly showing a polymeric material of the overmolded bracket disposed within open cells of the bumper;

FIG. 14 is a side view of a second embodiment of the bumper of the dampener assembly of FIG. 2;

FIG. 14A is a top perspective view of the dampener assembly of FIG. 14;

FIG. 14B is a front view of the dampener assembly of FIG. 14;

FIG. 14C is a bottom view of the dampener assembly of FIG. 14;

FIG. 15 is a side view of a third embodiment of the bumper of the dampener assembly of FIG. 2;

FIG. 15A is a top perspective view of the dampener assembly of FIG. 15;

FIG. 15B is a front view of the dampener assembly of FIG. 15;

FIG. 15C is a bottom view of the dampener assembly of FIG. 15;

FIG. 16 is a side view of a fourth embodiment of the bumper of the dampener assembly of FIG. 2;

FIG. 16A is a top perspective view of the dampener assembly of FIG. 16;

FIG. 16B is a front view of the dampener assembly of FIG. 16;

FIG. 16C is a bottom view of the dampener assembly of FIG. 16;

FIG. 17 is a side view of a fifth embodiment of the bumper of the dampener assembly of FIG. 2;

FIG. 17A is a top perspective view of the dampener assembly of FIG. 17;

FIG. 17B is a front view of the dampener assembly of FIG. 17;

FIG. 17C is a top view of the dampener assembly of FIG. 17;

FIG. 18 is a side view of a fourth embodiment of the overmolded bracket of the dampener assembly;

FIG. 19 is a side view of the fourth embodiment of the overmolded bracket defining first and second apertures of the dampener assembly;

FIG. 20 is a side view of the fourth embodiment of the overmolded bracket and a sixth embodiment of the bumper of the dampener assembly;

FIG. 21 is a side cross-sectional view of a fifth embodiment of the overmolded bracket and the second embodiment of the bumper of the dampener assembly.

### DETAILED DESCRIPTION OF THE INVENTION

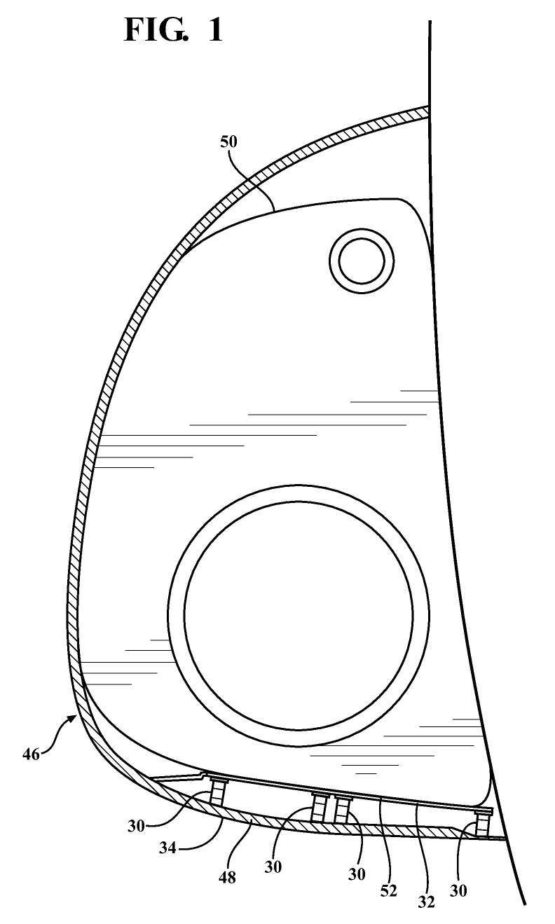

With reference to the Figures, wherein like numerals indicate like or corresponding parts throughout the several views, a dampener assembly is shown at 30. The dampener assembly 30 dampens vibrations between a first member 32 and a second member 34, as shown in FIG. 1. The dampener assembly includes a bumper 36 and an overmolded bracket 38. The bumper 36 comprises a cellular material. Although not required, the bumper 36 typically comprises a microcellular polyurethane. The overmolded bracket 38 comprises a polymeric material. Typically, the overmolded bracket 38 comprises thermoplastic polyurethane. The dampener assembly 30 may be formed by overmolding the overmolded bracket 38 around the bumper 36. More specifically, the bumper 36, which may be formed of a substrate comprising the microcellular polyurethane, may be directly bonded to the polymeric material of the overmolded bracket 38 by molding the overmolded bracket 38 to the bumper 36, as described in further detail below.

Generally, the microcellular polyurethane of the bumper 36 has a microcellular structure, i.e., the microcellular polyurethane presents cell walls 40 defining a plurality of cells 42, or void spaces. The cell walls 40 have an original shape and the cells 42 are generally filled with air. When the microcellular polyurethane is subjected to compressive forces, the cell walls 40 are collapsed and air evacuates from the cells 42. When the compressive forces are removed, the cell walls 40 return to the original shape. The use of microcellular polyurethane in compression applications is beneficial because the microcellular polyurethane has a progressive load deflection curve.

An example of a suitable microcellular polyurethane for this application is the type manufactured by BASF Corporation under the trade name Cellasto®. The microcellular polyurethane may be formed from a two-step process. In the first step of this exemplary process, an isocyanate prepolymer is formed by reacting a polyol and an isocyanate. The polyol is a polyester polyol, alternatively a polyether polyol. The isocyanate is monomeric methyldiphenyl diisocyanate, alternatively naphthalene diisocyanate. However, it should be appreciated that the isocyanate can be of any type without departing from the nature of the present invention. In the second step of this exemplary process, the isocyanate prepolymer reacts with water to generate carbon dioxide and the carbon dioxide forms the cells 42 of the microcellular polyurethane.

Polyester polyols that are produced from the reaction of a dicarboxylic acid and a glycol having at least one primary hydroxyl group are possible for use to make the microcellular polyurethane. Dicarboxylic acids that are suitable for producing the polyester polyols are selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for producing the polyester polyols are selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. The polyester polyol has a hydroxyl number of from 30 to 130, a nominal functionality of from 1.9 to 2.3, and a nominal molecular weight of from 1000 to 3000. Specific examples of polyester polyols suitable for the subject invention include Pluracol® Series commercially available from BASF Corporation of Florham Park, N.J.

Polyether polyols are produced from the cyclic ether propylene oxide, alternatively ethylene oxide or tetrahydrofuran. Propylene oxide is added to an initiator in the presence of a catalyst to produce the polyether polyol. Suitable polyether polyols are selected from the group of, but are not limited to, polytetramethylene glycol, polyethylene glycol, polypropylene glycol, and combinations thereof. The polyether polyol has a hydroxyl number of from 30 to 130, a nominal functionality of from 1.8 to 2.3, and a nominal molecular weight of from 1000 to 5000. Specific examples of polyether polyols suitable for the subject invention include Pluracol® 858, Pluracol® 538, Pluracol® 220, Pluracol® TP Series, Pluracol® GP Series, and Pluracol® P Series commercially available from BASF Corporation of Florham Park, N.J.

Diisocyanates suitable to make the microcellular polyurethane are selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof. Specific examples of diisocyanates suitable for the subject invention include Lupranate® 5143, Lupranate® MM103, and Lupranate® R2500U commercially available from BASF Corporation of Florham Park, N.J.

The monomeric methyldiphenyl diisocyanate is selected from the group of 4,4′-diphenylmethane diisocyanate, 2,4′-diphenylmethane diisocyanate, and combinations thereof. Specific examples of monomeric methyldiphenyl diisocyanates suitable for the subject invention include Lupranate® M and Lupranate® MS commercially available from BASF Corporation of Florham Park, N.J. The monomeric methyldiphenyl diisocyante may also be modified with carbonimide. Specific examples of carbonimide-modified monomeric methyldiphenyl diisocyante include Lupranate® 5143 and Lupranate® MM103 commercially available from BASF Corporation of Florham Park, N.J.

The polymeric material of the overmolded bracket 38 is typically a cast urethane. In other embodiments, the polymeric material of the overmolded bracket 38 may be selected from the group of thermoplastic materials, thermoset materials, engineered plastics, and combinations thereof. In various embodiments utilizing the thermoplastic material as the polymeric material, the thermoplastic material may be a thermoplastic elastomer (i.e., a “TPE”). Examples of suitable TPEs include those with or without cross-linking. In various embodiments utilizing the TPE as the polymeric material, the TPE is selected from the group of thermoplastic polyurethanes, thermoplastic etheresters, thermoplastic olefins, thermoplastic styrols, thermoplastic etheramides, and combinations thereof. In specific embodiments utilizing the thermoplastic material as the polymeric material, the thermoplastic material is the thermoplastic polyurethane, which may also be referred to in the art as a “TPU”. Alternatively, in various embodiments utilizing the thermoplastic material as the polymeric material, the thermoplastic material may be a polyamide. The polyamide may be elastomeric or non-elastomeric. Examples of suitable polyamides include PA 6, PA 6,6, and combinations thereof. The thermoplastic material of the overmolded bracket 38 is typically selected to be compatible with injection molding processes. Specific examples of a suitable thermoplastic polyurethane include Elastollan® commercially available from BASF Corporation of Florham Park, N.J.

As indicated above, in various embodiments the polymeric material can be a thermoset material. Examples of suitable thermoset materials include polyester fiberglass systems, polyurethanes, vulcanized rubbers, unvulcanized rubbers, phenol formaldehyde resins, resin plastics reinforced with fibers, such as Duroplast, melamine resins, melamine formaldehyde resins, epoxy resins, polyimides, cyanate esters, polycyanurates, and combinations thereof.

As indicated above, in various embodiments the polymeric material can be an engineered plastic. Examples of suitable engineered plastics include ultra-high-molecular-weight polyethylene (UHMWPE), polytetrafluoroethylene (PTFE/Teflon), acrylonitrile butadiene styrene (ABS), polycarbonates (PC), polyamides (PA), polybutylene terephthalate (PBT), polyethylene terephthalate (PET), polyphenylene oxide (PPO), polysulphone (PSU), polyetherketone (PEK), polyetheretherketone (PEEK), polyimides (PI), polyphenylene sulfide (PPS), polyoxymethylene plastic (POM/Acetal).

The polymeric material of the overmolded bracket 38 may include an additive. Suitable additives include, but are not limited to, non-fiber impact modifiers, fiber-based impact resistance additives, coupling agents, pigments, glass or carbon fibers, mineral or glass beads, stabilizers, and combinations thereof. Although not required, the polymeric material may be filled with fibers in an amount greater than 10, from 10 to 75, and from 20 to 60 percent weight based on a combined total weight of the polymeric material and the fibers. Typically, the fibers are glass fibers; however, it should be appreciated that the fibers may include other material or other materials in combination with glass. For example, it is to be appreciated that the fibers may be inorganic fibers, such as glass. The fibers may also be organic fibers, including carbon fibers and polymeric fibers, such as nylon. The fibers may vary in size (e.g. length, diameter, etc.) and may be coated or uncoated. The polymeric material or the fibers may each include other components to encourage bonding between the polymeric material and the fibers.

A method of making the bumper 36 includes the step of providing the substrate comprising a cellular material, typically the microcellular polyurethane. The substrate is placed into a mold. The mold includes a main cavity and a main core. The main cavity and the main core are moveable relative to each other between a closed position for securing the substrate comprising the cellular material within the mold and an open position for removal of the bumper 36 from the mold. Therefore, the method may further include the steps of moving the mold to the open position, prior to the step of placing the substrate comprising the cellular material into the mold, and then moving the mold to the closed position once the substrate comprising the cellular material is placed within the mold. The mold may include features to ensure proper location of the material in the mold. For example, the mold can include locating holes, draft angles, etc. Additionally, the mold may be treated with a release agent before the substrate comprising the cellular material is placed in the mold to promote separation of the bumper 36 from the mold. Depending on the shape of the bumper 36, a water jet may cut the bumper 36.

The polymeric material of the overmolded bracket 38 is typically selected to be compatible with the molding processes described below. Typically, cast molding is employed. When cast molding is employed, the polymeric material used may be a polyurethane. In such an embodiment, the process may be described as cast urethane molding. The polymeric material is introduced into the mold. Although not required, the polymeric material may be injected into the mold. It is to be appreciated that other methods besides cast molding or injection molding could be used, such as reactive injection molding, extrusion molding, compressive molding, spin casting, and vulcanization. In another embodiment, when vulcanization is employed, the polymeric material and the microcellular polyurethane are fused together. The polymeric material is disposed over a mounting surface 44 of the bumper 36 within the mold to form the overmolded bracket 38, which is coupled to the bumper 36 thereby making the dampener assembly 30. The polymeric material for the overmolded bracket 38 may be heated to a molten state with the polymeric material for the overmolded bracket 38 applied to the mounting surface 44 of the bumper 36 in the molten state. Subsequently, the polymeric material is allowed to cool and solidify thereby forming the overmolded bracket 38. The dampener assembly 30 is then released from the mold.

When the polymeric material is injected into the mold, the step of heating the polymeric material and injecting the polymeric material into the mold is further defined as molding. In such a configuration, the polymeric material is typically injected into the mold under pressure.

The method may further include the step of promoting interaction between the polymeric material of the overmolded bracket 38 and the microcellular polyurethane of the bumper 36 to integrate the overmolded bracket 38 and the bumper 36. The step of promoting the interaction between the polymeric material of the overmolded bracket 38 and the microcellular polyurethane of the bumper 36 combines the overmolded bracket 38 and the bumper 36 into a single unit. In other words, when the polymeric material is introduced into contact with the bumper 36, the polymeric material of the overmolded bracket 38 and the microcellular polyurethane of the bumper 36 interact with one another such that the overmolded bracket 38 and the bumper 36 are integral with each other, i.e., one-piece. In some embodiments, the polymeric material may be in a molten state prior to contact with the bumper 36 such that when the polymeric material of the overmolded bracket 38 and the cellular material of the bumper 36 interact with one another, upon cooling, the overmolded bracket 38 and the bumper 36 are integral with one another, i.e., are one piece.

Generally, the cells 42 of the microcellular polyurethane of the bumper 36 receive the polymeric material of the overmolded bracket 38 to mechanically engage the overmolded bracket 38 to the bumper 36. As alluded to above, the dampener assembly 30 is typically formed by molding the polymeric material of the overmolded bracket 38 about the bumper 36. During this process, the polymeric material of the overmolded bracket 38 is in a molten state and flows into the cells 42 of the microcellular polyurethane of the bumper 36 such that, upon solidification of the polymeric material of the overmolded bracket 38, the overmolded bracket 38 and the bumper 36 are mechanically engaged with one another. It is to be appreciated that the overmolded bracket 38 and the bumper 36 can be mechanically engaged with one another in any fashion. For example, the bumper 36 could define other features such as studs, hooks, etc.

It is also to be appreciated that a melt bond may be formed between the polymeric material of the overmolded bracket 38 and the microcellular polyurethane of the bumper 36. Melt bonding occurs when the polymeric material of the overmolded bracket 38 in the molten state interacts with the microcellular polyurethane of the bumper 36 while the microcellular polyurethane is in a heated softened state. The polymeric material of the overmolded bracket 38 and the microcellular polyurethane of the bumper 36 interact with one another such that, upon cooling, the polymeric material of the overmolded bracket 38 and the microcellular polyurethane of the bumper 36 are bonded together. Specifically, heat may be transferred from the polymeric material of the overmolded bracket 38 in the molten state to the microcellular polyurethane of the bumper 36. The heat softens the microcellular polyurethane and the softened microcellular polyurethane interacts with the polymeric material in the molten state. As the polymeric material cools to solidify and form the overmolded bracket 38, the softened microcellular polyurethane of the bumper 36 also cools and hardens forming a bond with the polymeric material of the overmolded bracket 38.

In addition to heat transfer from the polymeric material of the overmolded bracket 38, the softening of the microcellular polyurethane of the bumper 36 may be promoted in a variety of ways. For example, the method may include the step of softening the microcellular polyurethane by heating the mold to conductively heat the bumper 36. The bumper 36 may be heated such that less heat energy is required from the polymeric material of the overmolded bracket 38 in the molten state to soften the microcellular polyurethane of the bumper 36. Alternatively, or in addition, the method may include heating the bumper 36 prior to disposing the polymeric material of the overmolded bracket 38 in the molten state into contact with the bumper 36. For example, the method may include heating the bumper 36 prior to placing the bumper 36 into the mold. Alternatively or in addition, the method may include the step of heating the bumper 36 while the bumper 36 is disposed in the mold. It is to be appreciated that the mold and/or the bumper 36 can be heated in a suitable manner, such as applying heated air to the mold and/or bumper 36.

The method may also include the step of preparing the mounting surface 44 of the bumper 36 prior to the step of introducing the polymeric material of the overmolded bracket 38 into the mold. For example, the mounting surface 44 of the bumper 36 can be prepared by removing a skin of the bumper 36 for exposing cells 42 of the bumper 36 at the mounting surface 44. Additionally, the mounting surface 44 of the bumper 36 can be prepared by removing a portion of the bumper 36 to expose the cells 42 of the bumper 36 at the mounting surface 44. Furthermore, the mounting surface 44 of the bumper 36 can be prepared by machining the bumper 36 to expose the cells of the bumper 36 at the mounting surface 44.

Typically, after forming the microcellular polyurethane, the mounting surface 44 of the microcellular polyurethane forms a skin. The skin limits access to the cells 42 of the microcellular polyurethane at the mounting surface 44. The skin may be the result of exposure of the microcellular polyurethane to air and/or ultraviolet light. Therefore, the mounting surface 44 of the bumper 36 is typically prepared for exposing the cells 42 of the microcellular polyurethane to ensure interaction of the polymeric material with the cells 42 of the microcellular polyurethane. Said differently, the skin of the microcellular polyurethane is removed prior to overmolding the polymeric material around the microcellular polyurethane. Additionally, the preparation of the mounting surface 44 of the bumper 36 may also remove any of the release agent, which was applied to the mold, that might have contacted the bumper 36 and been disposed on the mounting surface 44 of the bumper 36.

It is to be appreciated that the method may further include the step of cutting the bumper 36 to provide the mounting surface 44. For example, the bumper 36 can be cut from a stock piece of material for providing the bumper 36 and also for exposing the cells 42 of the bumper 36. Depending on the shape of the bumper 36, the bumper 36 is cut, which results in a cut surface of the bumper 36, which has the cells 42 of the microcellular polyurethane exposed. Therefore, the cut surface of the bumper 36 would be the mounting surface 44 for receiving the polymeric material within the mold. As described above, depending on the shape of the bumper 36, a water jet may cut the bumper 36 prior to overmolding the polymeric material of the overmolded bracket 38.

Most typically, the dampener assembly 30 prevents the first member 32 and the second member 34 from directly impacting each other. At least one of the first member 32 and the second member 34 are moveable relative to the other one of the first and second members 32, 34. In one embodiment, the dampener assembly 30 is used in a vehicle. For example, the dampener assembly 30 can be placed in or on a floor of the vehicle to provide a soft ride by reducing noise and vibrations. The dampener assembly 30 can also be used with a suspension system of a vehicle. In such an embodiment, the dampener assembly 30 minimizes a transfer of impact forces experienced by wheels of the vehicle to a frame of the vehicle and, ultimately, to occupants within the vehicle. It is to be appreciated that the dampener assembly 30 may be used in any application in the vehicle for dampening vibrations between any components that are movable relative to each other.

In another embodiment, the dampener assembly 30 is used in an aircraft. The aircraft may be a helicopter, plane, jet, etc. For example, the dampener assembly 30 can be placed in or on the floor of the aircraft to reduce noise and dampen vibrations from a propeller or jet engine of the aircraft. The dampener assembly 30 can also be used to dampen vibrations within a fuel cell 46, as shown in FIG. 1 and as described in further detail below. The fuel cell 46 typically comprises an outer casing 48 and a bladder 50 with the outer casing 48 encapsulating the bladder 50. In some embodiments, the fuel cell 46 comprises an isolation floor 52. Fuel is disposed within the bladder 50 of the fuel cell 46. The dampener assembly 30 is coupled to the isolation floor 52 of the fuel cell 46 such that the dampener assembly 30 is disposed between the isolation floor 52 and the outer casing 48. Specifically, the mounting surface 44 of the overmolded bracket 38 is mounted to the outer casing 48 of the fuel cell 46 such that the bumper 36 contacts the outer casing 48 of the fuel cell 46 of the helicopter, which allows the dampener assembly 30 to reduce vibrations caused by the outer casing 48 and the isolation floor 52 being movable relative to each other. The outer casing 48 and the isolation floor 52 of the helicopter may move relative to each other due to vibrations caused from a helicopter rotor. The outer casing 48 and the isolation floor 52 of the helicopter may move relative to each other due to the fuel within the bladder 50 moving relative to the outer casing 48, which, in turn, causes the isolation floor 52 to move relative to outer casing 48. It is to be appreciated that the fuel cell 46 may be a fuel tank, batteries, or the like. It is also to be appreciated that the fuel cell 46 may be one or more components.

In another embodiment, the dampener assembly 30 is coupled to the outer casing of the fuel cell 46 such that the dampener assembly 30 is disposed between the fuel cell 46 and a frame of the helicopter. Specifically, the mounting surface 44 of the overmolded bracket 38 is mounted to the outer casing 48 of the fuel cell 46 such that the bumper 36 contacts the frame of the helicopter, which allows the dampener assembly 30 to reduce vibrations caused by the fuel cell 46 and the frame being movable relative to each other. The fuel cell 46 and the frame of the helicopter may move relative to each other due to vibrations caused from a helicopter rotor. The fuel cell and the frame of the helicopter may move relative to each other due to the fuel within the fuel cell 46 moving relative to the frame, which, in turn, causes the fuel cell 46 to move relative to the frame.

The dampener assembly 30 is used in the aircraft to prevent the fuel cell 46 and the frame of the aircraft from impacting each other. It is to be appreciated that the dampener assembly 30 may be used in other locations of the aircraft to prevent other components from vibration transfer.

As indicated above, the dampener assembly 30 can be any suitable structure for absorbing vibration or loads between the first 32 and second 34 members. Examples of suitable dampener assemblies 30 include, but are not limited to, spring isolators, jounce bumpers, vibration dampening mounts for vibration sensitive equipment (avionics), engine mounts for NVH reduction, and bump stops.

To couple the overmolded bracket 38 to the bumper 36, the bumper 36 is placed into the mold and the polymeric material is injected into the mold and over the mounting surface 44 of the bumper 22 to form the overmolded bracket 38, which is thereby coupled to the bumper 36 to make the dampener assembly 30. The dampener assembly 30 is released from the mold.

The method of making the dampener assembly 30 may include the step of preparing the mounting surface 44 of the bumper 36 prior to the step of injecting the polymeric material into the mold. Additionally, the method steps for preparing the mounting surface 44 may be further defined as removing a skin of the bumper 36 to expose the cells 42 of the bumper 36 at the mounting surface 44. The skin of the bumper 36 may be removed only at the mounting surface 44 of the bumper 36 to increase the mechanical and/or melt bond between the microcellular polyurethane of the bumper 36 and the polymeric material of the overmolded bracket 38, while leaving the skin of the bumper 36 on the remainder of the bumper 36 to increase resistance to wear.

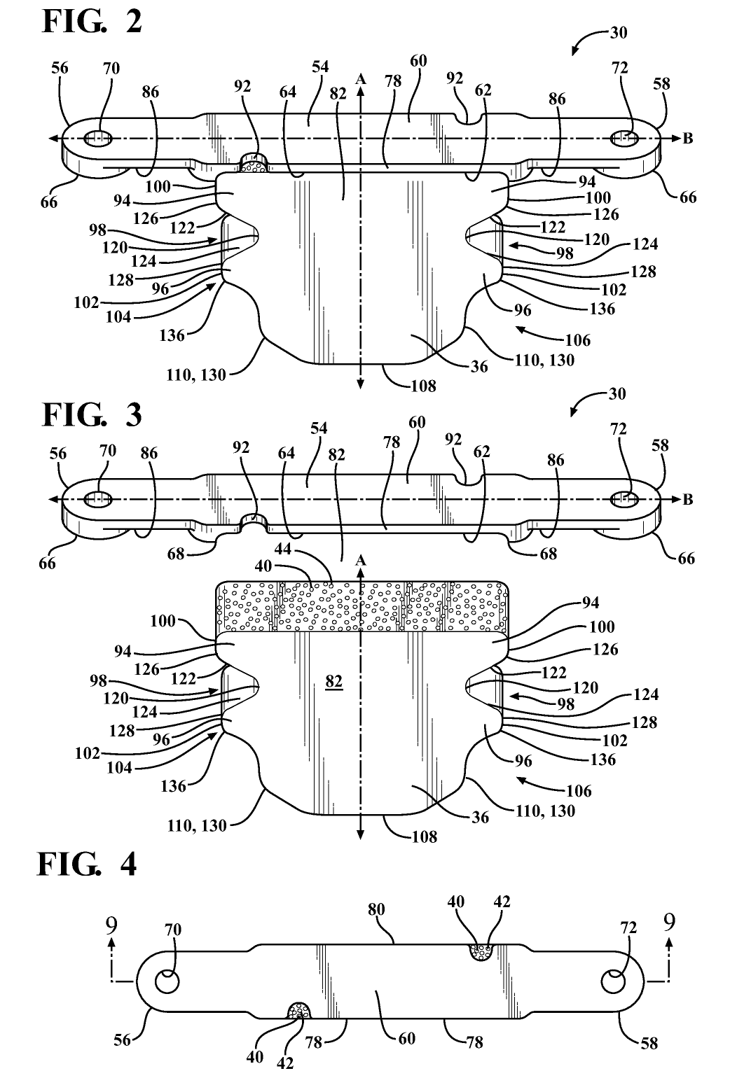

With further reference to the Figures and, more specifically to FIG. 2, the dampener assembly 30 comprises the bumper 36 which extends along a central axis A. The dampener assembly 30 also comprises the overmolded bracket 38 coupled to the bumper 36, as described in further detail below. The bumper 36 comprises the cellular material defining the plurality of cells 42. Specifically, the bumper 36 has cell walls 40 defining the plurality of cells 42, as best shown in FIG. 13. The cell walls 40 collapse as air evacuates from the plurality of cells 42 and the bumper 36 is thereby deformed. When the compressive forces are removed from the bumper 36, the cell walls 40 return to the original shape and the bumper 36 thereby regains its form. Because the cell walls 40 collapse when subjected to compressive forces, the bumper 36 experiences minimal bulge (outward expansion) when compressed. As the bumper 36 is compressed, the bumper 36 absorbs energy. Because the cell walls 40 are collapsing as the load increases, the bumper 36 becomes less compressible. When the cell walls 40 are completely collapsed, the bumper 36 is no longer compressible. A portion of the plurality of cells 42 are open at the mounting surface 44 of the bumper 36.

The overmolded bracket 38 comprises the polymeric material. The overmolded bracket 38 has a body portion 54 with the body portion 54 extending between a first bracket end 56 and a second bracket end 58 along a longitudinal axis B. The body portion 54 of the overmolded bracket 38 has an attachment surface 60 configured to couple to the first member 32. The body portion 54 has a bonding surface 62 opposite the attachment surface 60. The bonding surface 62 is coupled to the bumper 36, which, in turn, couples the overmolded bracket 38 to the bumper 36. As shown in FIG. 13, the polymeric material of the overmolded bracket 38 is disposed within the open cells 42 at the mounting surface 44 of the bumper 36 for bonding the overmolded bracket 38 and the bumper 36 to one another.

The bumper 36 may be directly coupled to the overmolded bracket 38. In one embodiment, the polymeric material of the overmolded bracket 38 is disposed within at least 20 percent of the open cells at the mounting surface 44 for bonding the overmolded bracket 38 and the bumper 36 to one another. It is to be appreciated that the polymeric material of the overmolded bracket 38 may be disposed within more or less than 20 percent of the open cells 42 at the mounting surface 44 without departing from the nature of the present invention.

In one embodiment, the dampener assembly 30 is free of adhesive between the mounting surface 44 of the bumper 36 and the bonding surface 62 of the overmolded bracket 38. By eliminating the use of adhesive to couple the overmolded bracket 38 to the bumper 36, the method of making the dampener assembly 30 has a quicker cycle time as compared to methods that would require a step of applying the adhesive. Additionally, the mechanical and/or melt bond between the cellular material of the bumper 36 and the polymeric material of the overmolded bracket 38 may be stronger than a bond of currently used adhesives. For example, with known dampening devices having a bumper and a bracket using adhesives, repeated compression of the bumper can result in a failure of the adhesive over time, which results in a walking-out or separation of the bracket with the bumper, which occurs more frequently than with the method of this invention described above. To achieve a coupling of the overmolded bracket 38 to the bumper 36, the overmolded bracket 38 of the dampener assembly 30 may be overmolded onto the bumper 36, as described in further detail above.

In one embodiment, the polymeric material of the overmolded bracket 38 may be comprised of thermoplastic polyurethane, which provides additional rigidity and support to the bumper 36. The overmolded bracket 38 secures the bumper 36 in the proper position while the bumper 36 is free to compress. In one embodiment, the bumper 36 is comprised of microcellular polyurethane. Microcellular polyurethane provides several advantages over alternative materials used in bumpers. Specifically, when the bumper 36 is formed of microcellular polyurethane and subjected to compressive forces, the cell walls 40 of the microcellular polyurethane collapse as air evacuates from the cells 42, as described in further detail above. Typically, when the overmolded bracket 38 comprises thermoplastic polyurethane, the bumper 36 comprises microcellular polyurethane.

In one embodiment, the bonding surface 62 of the overmolded bracket 38 defines a recess 64 with the mounting surface 44 of the bumper 36 bonded to the bonding surface 62 within the recess 64, as shown in FIGS. 2-17C. The overmolded bracket 38 has an end surface 66 opposite the attachment surface 60 at each of the first 56 and second 58 bracket ends. In this embodiment, the overmolded bracket 38 has a retaining wall 68 extending from the bonding surface 62 perpendicular relative to the attachment surface 60 and beyond the end surface 66. The retaining wall 68 defines a portion of the recess 64 thereby increasing a depth of the recess 64. A contact surface area is defined between the mounting surface 44 of the bumper 36 and the bonding surface 62 of the overmolded bracket 38. The retaining wall 68 contacts the mounting surface 44 of the bumper 36 for increasing the contact surface area.

In one embodiment, the first bracket end 56 may define a first aperture 70 between the end surface 66 and the attachment surface 60, and the second bracket end 58 may define a second aperture 72 between the end surface 66 and the attachment surface 60. When the first bracket end 56 defines the first aperture 70 and the second bracket end 58 defines the second aperture 72, the dampener assembly 30 may additionally include a first insert 74 disposed in the first aperture 70 and a second insert 76 disposed in the second aperture 72, as shown in FIGS. 10 and 21. The first insert 74 and the second insert 76 reinforce the overmolded bracket 38 at the first aperture 70 and second aperture 72, respectively.

In this embodiment, the first insert 74 may be disposed fully within the first aperture 70 such that the first insert 74 is disposed within the first aperture 70 between the attachment surface 60 and the end surface 66. In this embodiment, the first insert 74 may extend the full length between the attachment surface 60 and the end surface 66, or the first insert 74 may not extend the full length between the attachment surface 60 and the end surface 66 without departing from the nature of the present invention. On the other hand, the first insert 74 may be partially disposed within the first aperture 70 such that the first insert 74 is not fully disposed between the attachment surface 60 and the end surface 66. In other words, the first insert 74 may extend beyond the end surface 66 with respect to the attachment surface 60, and/or the first insert 74 may extend beyond the attachment surface 60 with respect to the end surface 66. Likewise, the second insert 76 may be disposed fully within the second aperture 72, or partially disposed within the second aperture 72 in the same manner described above for the first insert 74 and the first aperture.

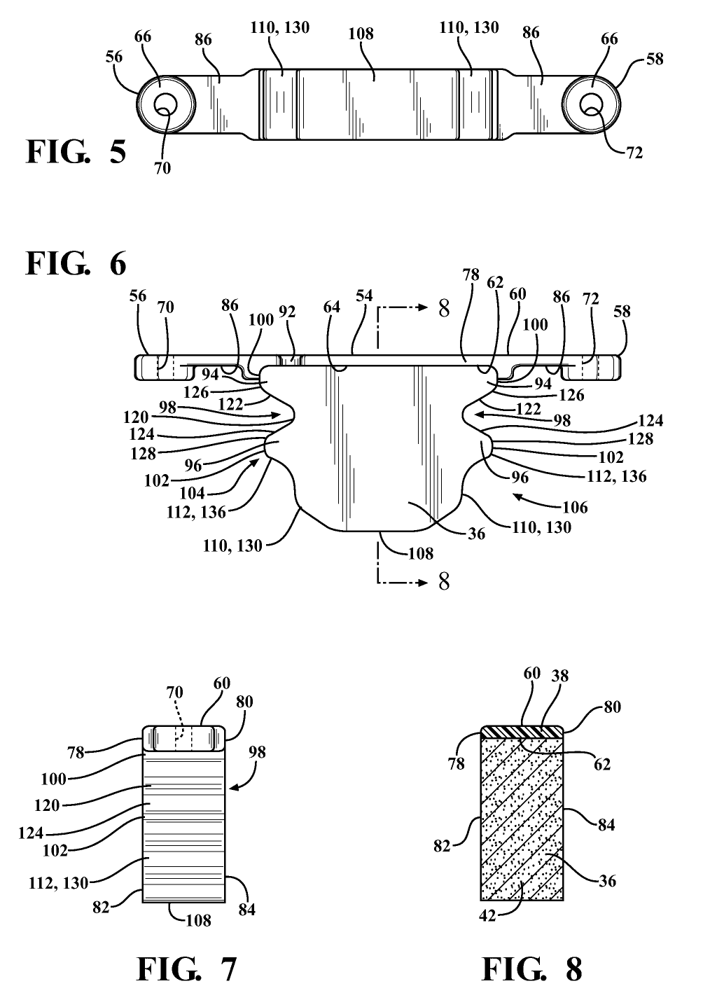

The overmolded bracket 38 has a first bracket side 78 and a second bracket side 80 opposite the first bracket side 78 along the longitudinal axis B. Typically, the first bracket side 78 and the second bracket side 80 are parallel to one another, as best shown in FIGS. 5, 7, and 8. The bumper 36 may have a first bumper side 82 and a second bumper side 84 each extending perpendicular relative to the attachment surface 60 of the overmolded bracket 38. In this embodiment, the first bumper side 82 is parallel to the first bracket side 78 and the second bumper side 84 is parallel to the second bracket side 80. The first bumper side 82 may be flush with the first bracket side 78 and the second bumper side 84 may be flush with the second bracket side 80.

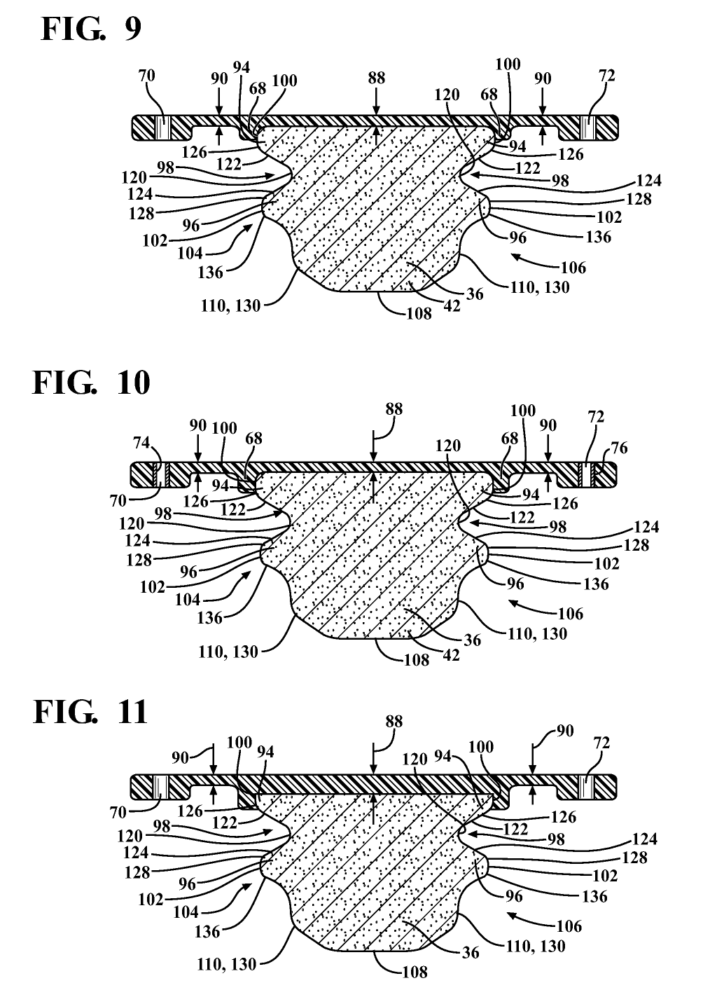

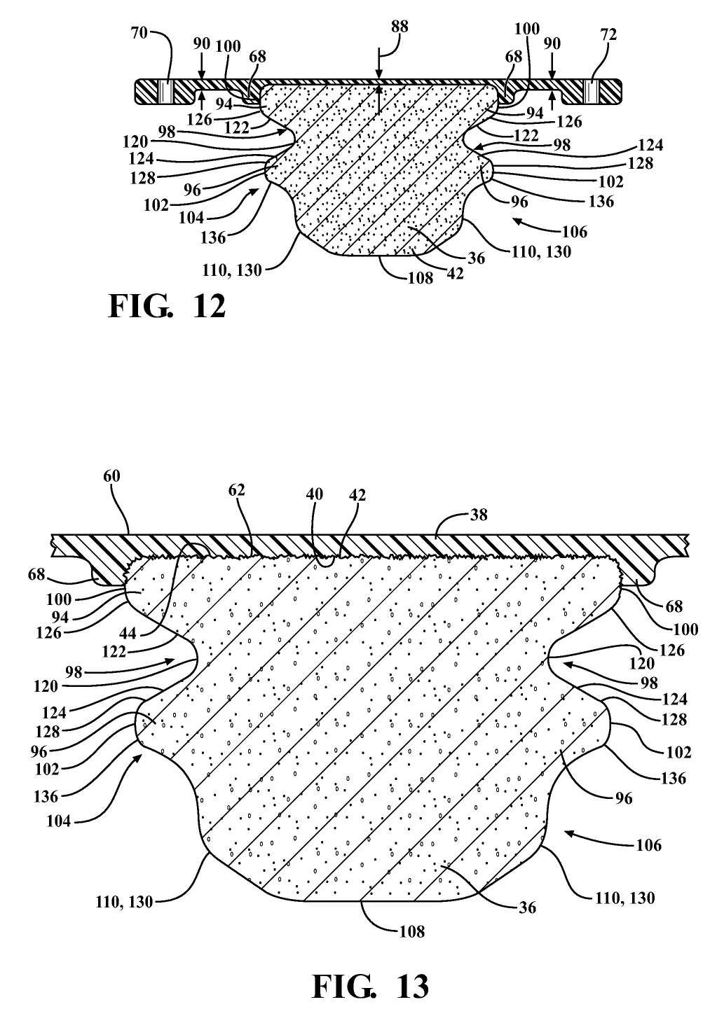

In one embodiment, the overmolded bracket 38 has a body surface 86 opposite the attachment surface 60 and disposed between the first bracket end 56 and the second bracket end 58. With reference to FIGS. 9-12, the overmolded bracket 38 has a first thickness 88 between the body surface 86 and the attachment surface 60 at the first and second bracket ends 56, 58. The overmolded bracket 38 has a second thickness 90 between the bonding surface 62 and the attachment surface 60. Typically, the first thickness 88 is equal to the second thickness 90, as shown in FIGS. 9 and 10. In this embodiment, the bumper 36 extends along a central axis A, and the body surface 86 of the overmolded bracket 38 is disposed between the end surface 66 and the attachment surface 60 along the central axis A. It is to be appreciated that the first thickness 88 may be greater than the second thickness 90, as shown in FIG. 11, and that the second thickness 90 may be greater than the first thickness 88, as shown in FIG. 12, without departing from the nature of the present invention. Decreasing the first thickness 88 with respect to the second thickness 90 may increase the contact surface area of the mechanical and/or melting bond between the overmolded bracket 38 and the bumper 36. Alternatively, increasing the first thickness 88 with respect to the second thickness 90 may increase or decrease the contact surface area of the mechanical and/or melting bond between the overmolded bracket 38 and the bumper 36 depending on the configuration of the retaining wall 68.

As best shown in FIG. 2, the first bracket end 56 and the second bracket end 58 of the overmolded bracket 38 may each independently define a cutout 92 for weight reduction of the overmolded bracket, which is desirable in applications where the dampener assembly 30 is utilized in aircraft.

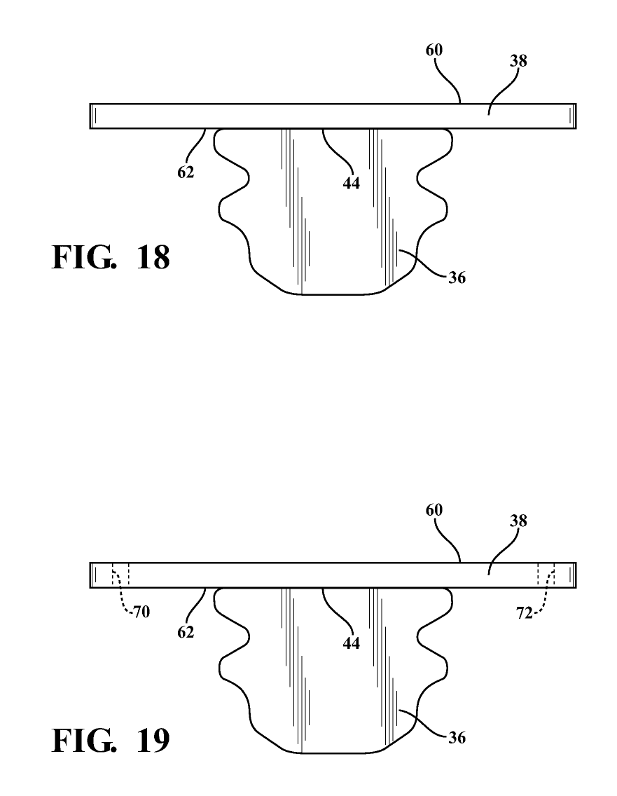

In one embodiment, the bumper 36 has a first bumper portion 94 bonded to the bonding surface 62 of the overmolded bracket 38, and a second bumper portion 96 extending from the first bumper portion 94 opposite the overmolded bracket 38. Although not required, the first bumper portion 94 and the second bumper portion 96 are typically integral with one another. The first bumper portion 94 and the second bumper portion 96 may define a valley 98 therebetween, as shown in FIGS. 2, 3, 6, 7, 9-14B, 15-15B, 16-16B, 17-17B, 18, 19, and 21. Additionally, the bonding surface 62 may define the recess 64 with the bonding surface 62 disposed between the end surface 66 and the attachment surface 60 of the overmolded bracket 38 along the central axis A, with the first bumper portion 94 partially disposed within the recess 64 and bonded to the bonding surface 62 of the overmolded bracket 38, as shown in FIGS. 2, 5, 6, 9-14A, 15, 15A, 16, 16A, 17, 17A, and 21.

The first bumper portion 94 has a first bumper surface 100 having a first perimeter about the central axis A, and the second bumper portion 96 has a second bumper surface having a second perimeter about the central axis A. Specifically, the first perimeter of the first bumper portion 94 is defined about the central axis A and parallel to the longitudinal axis B along the first bumper surface 100, the first bumper side 82, and the second bumper side 84. Also, the second perimeter of the second bumper portion 96 is defined about the central axis A and parallel to the longitudinal axis B along the second bumper surface 102, the first bumper side 82, and the second bumper side 84. The first perimeter is typically greater than the second perimeter, as shown in FIGS. 2-21. However, it is to be appreciated that the second perimeter may be greater than the first perimeter, or that the first and second perimeters may be equal to one another without departing from the nature of the present invention.

It is to be appreciated that the first and second bumper portions 94, 96 can be of any shape suitable for accommodating compressive forces. For instance, the first bumper portion 94 may be a first rectangularly shaped prism and the second bumper portion 96 may be a second rectangularly shaped prism, where the first rectangularly shaped prism has a first volume and the second rectangularly shaped prism has a second volume. The first volume is typically greater than the second volume, as shown in FIGS. 2-21. However, it is to be appreciated that the second volume may be greater than the first volume without departing from the nature of the present invention. The first rectangularly shaped prism has a rectangular cross-section perpendicular to the longitudinal axis B and along the central axis A, and the second rectangularly shaped prism has a rectangular cross-section perpendicular to the longitudinal axis B and along the central axis A. As another example, the first bumper portion 94 and the second bumper portion 96 may be cylindrical or any three-dimensional shape without departing from the nature of the present invention. Depending on the application of the dampener assembly 30, the three-dimensional shape of first and second bumper portions 94, 96 is selected. For example, when the dampener assembly 30 is used in tight spaces or when multiple dampener assemblies 30 are used in certain applications, the first and second bumper portions 94, 96 are typically rectangularly-shaped prisms, which typically results in the dampener assembly 30 using less space. Further, the rectangularly shaped prism of the first and second bumper portions 94, 96 may allow multiple dampener assemblies 30 to align with each other. It is also to be appreciated that the bumper 36 may include a hollow interior extending along the central axis A.

The bumper 36 additionally includes a third bumper side 104 perpendicular to the first 82 and second 84 bumper sides, and a fourth bumper side 106 opposite the third bumper side 104, as best shown in FIG. 2. In one embodiment, the third bumper side 104 and the fourth bumper side 106 define the valley 98, and the first bumper side 82 is parallel to the first bracket side 78, and the second bumper side 84 is parallel to the second bracket side 80. In this embodiment, the first bumper side 82 may be flush with the first bracket side 78, and the second bumper side 84 may be flush with the second bracket side 80, as shown in FIG. 7.

When the bumper 36 has the first bumper portion 94 and the second bumper portion 96, the bumper 36 additionally may have an outermost bumper surface 108 parallel to the attachment surface 60 of the overmolded bracket 38. In this embodiment, the bumper 36 additionally has an edge 110 extending from the second bumper surface 102 to the outermost bumper surface 108 and toward the central axis A. The edge 110 may have a convex configuration along the central axis A with respect to the overmolded bracket 38, as shown in FIGS. 2 and 3. The edge 110, as described below, may be further defined as a third edge 130. It is to be appreciated that the outermost bumper surface 108 may terminate at a rounded or arcuate end such that the outermost bumper surface 108 is not parallel to the attachment surface 60 without departing from the nature of the present invention.

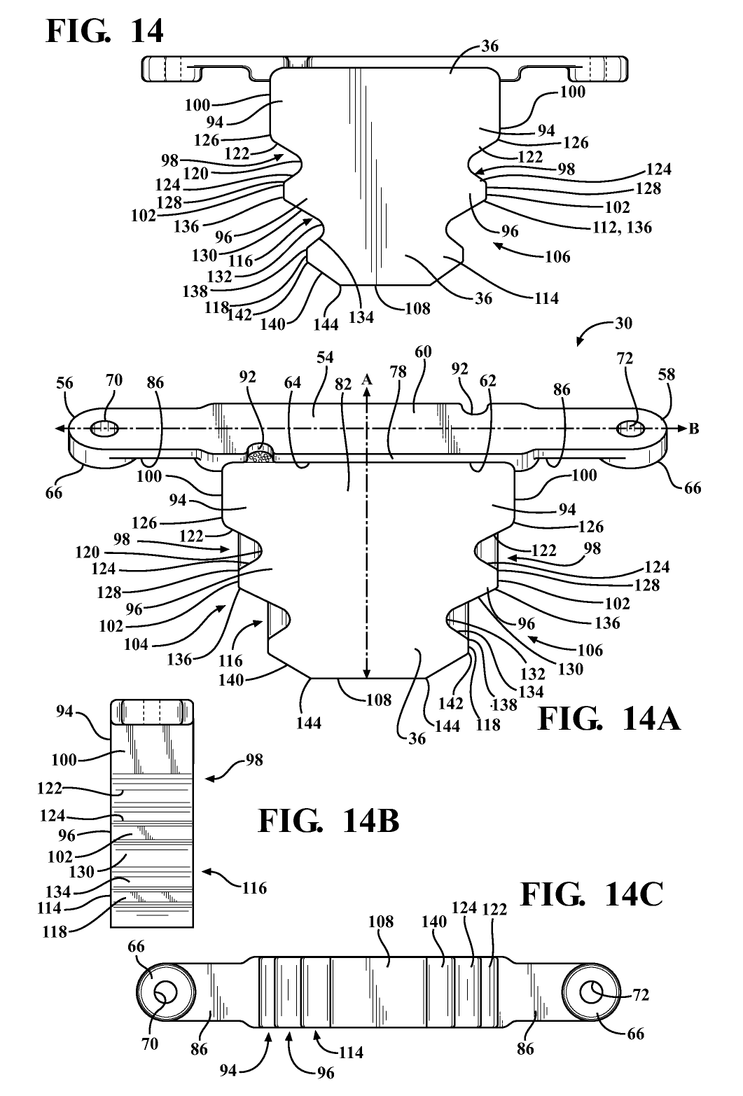

The bumper 36 may further include a third bumper portion 114 extending from the second bumper portion 96 opposite the first bumper portion 94 with the second bumper portion 96 and the third bumper portion 114 defining a second valley 116 therebetween, as shown in FIGS. 14, 14A, 15, 15A, 17, 17A, and 21. Although not required, the first bumper portion 94, the second bumper portion 96, and the third bumper portion 114 are typically integral with one another.

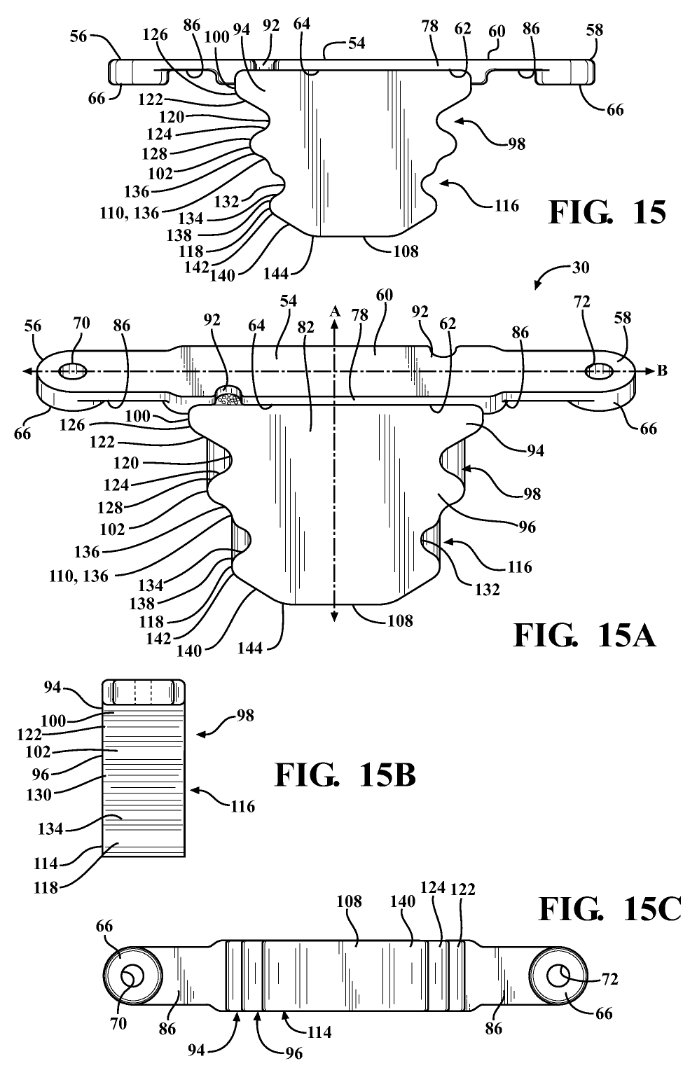

The first bumper portion 94 may be a first rectangularly shaped prism having a first volume, the second portion may be a second rectangularly shaped prism having a second volume, and the third bumper portion 114 may be a third rectangularly shaped prism having a third volume. In one embodiment, the first volume is greater than the second volume, and the second volume is greater than the third volume, as shown in FIGS. 14 and 15. It is to be appreciated that the first volume, the second volume, and the third volume may vary with respect to each other without departing from the nature of the present invention. For example, the first volume, the second volume, and the third volume may be equal to one another. Also, the second volume may be greater than the first volume, and the third volume may be greater than the second volume. Also, the second volume may be greater than both the first volume and the third volume. Further, the first volume may be greater than the second volume and the second volume may be equal to the third volume. It is to be appreciated that any of the first, second, and third volumes may be greater than or equal to the other of the first, second, and third volumes without departing from the nature of the present invention. The first rectangularly shaped prism has a rectangular cross-section perpendicular to the longitudinal axis B and along the central axis A, the second rectangularly shaped prism has a rectangular cross-section perpendicular to the longitudinal axis B and along the central axis A, and the third rectangularly shaped prism has a rectangular cross section perpendicular to the longitudinal axis B and along the central axis A. The first bumper portion 94, the second bumper portion 96, and the third bumper portion 114 may be cylindrical or any three-dimensional shape, depending on the application of the dampener assembly 30, as described above, without departing from the nature of the present invention. It is also to be appreciated that the bumper 36 may include a hollow interior extending along the central axis A.

When the bumper 36 has the first bumper portion 94, the second bumper portion 96, and the third bumper portion 114, the third bumper side 104 and the fourth bumper side typically define the valley 98 and the second valley 116, and the first bumper side 82 is typically parallel to the first bracket side 78, and the second bumper side 84 is typically parallel to the second bracket side 80. In this embodiment, the first bumper side 82 may be flush with the first bracket side 78, and the second bumper side 84 may be flush with the second bracket side 80.

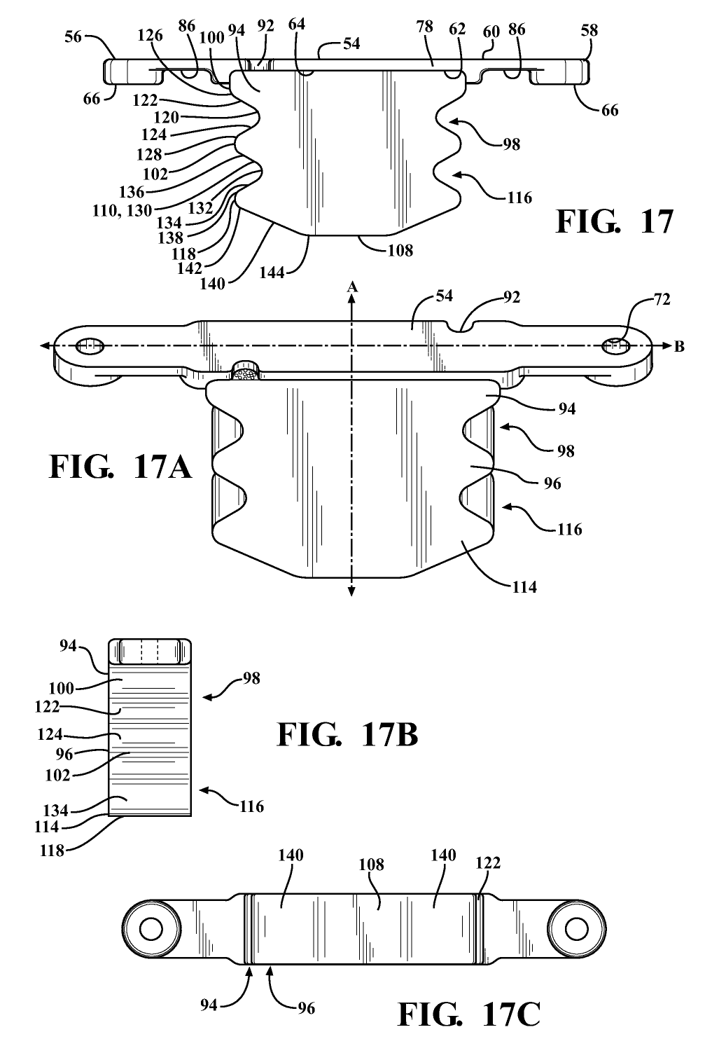

In addition to the first bumper portion 94 having the first perimeter and the second bumper portion 96 having the second perimeter, the third bumper portion 114 has a third bumper surface 118 having a third perimeter about the central axis A. Specifically, the third perimeter of the third bumper portion 114 is defined about the central axis A and parallel to the longitudinal axis B along the third bumper surface 118, the first bumper side 82, and the second bumper side 84. Typically, the first, second, and third perimeters are rectangularly-shaped perimeters. It is to be appreciated that the first, second, and third perimeters may vary with respect to each other without departing from the nature of the present invention. For example, the third perimeter may be greater than the second perimeter. Further, the first perimeter may be greater than the second and third perimeter with the second and third perimeter equal to one another, as shown in FIG. 17. It is to be appreciated that any of the first, second, and third perimeters may be greater than the other of the first, second, and third perimeters without departing from the nature of the present invention. It is also to be appreciated that the first, second, and third perimeters may be equal to each other without departing from the nature of the present invention. It is to be further appreciated that the first bumper portion 94, the second bumper portion 96, and the third bumper portion 114 may have perimeters other than rectangularly-shape perimeters, such as a circular perimeter, i.e., a circumference, without departing from the nature of the present invention.

As described above, the first bumper portion 94 and the second bumper portion 96 may define the valley 98 therebetween. When the first bumper portion 94 and the second bumper portion 96 define the valley 98, the first bumper portion 94 and the second bumper portion may define a fillet 120 therebetween, as shown in FIGS. 2, 3, and 9-17. Specifically, the first bumper portion 94 has a first edge 122 extending from the first bumper surface 100 to the fillet 120 and away from the overmolded bracket 38 along the central axis A, and the second bumper portion 96 has a second edge 124 extending from the second bumper portion 96 to the fillet 120 and toward the overmolded bracket 38 along the central axis A. The first edge 122 and the second edge 124 cooperatively define the valley 98. In some embodiments, the first edge 122 defines half of the valley 98 and the second edge 124 defines the other half of the valley 98. The first edge 122 and the first bumper surface 100 intersect and may form a first rounded corner 126, and the second edge 124 and the second bumper surface 102 intersect and may form a second rounded corner 128.

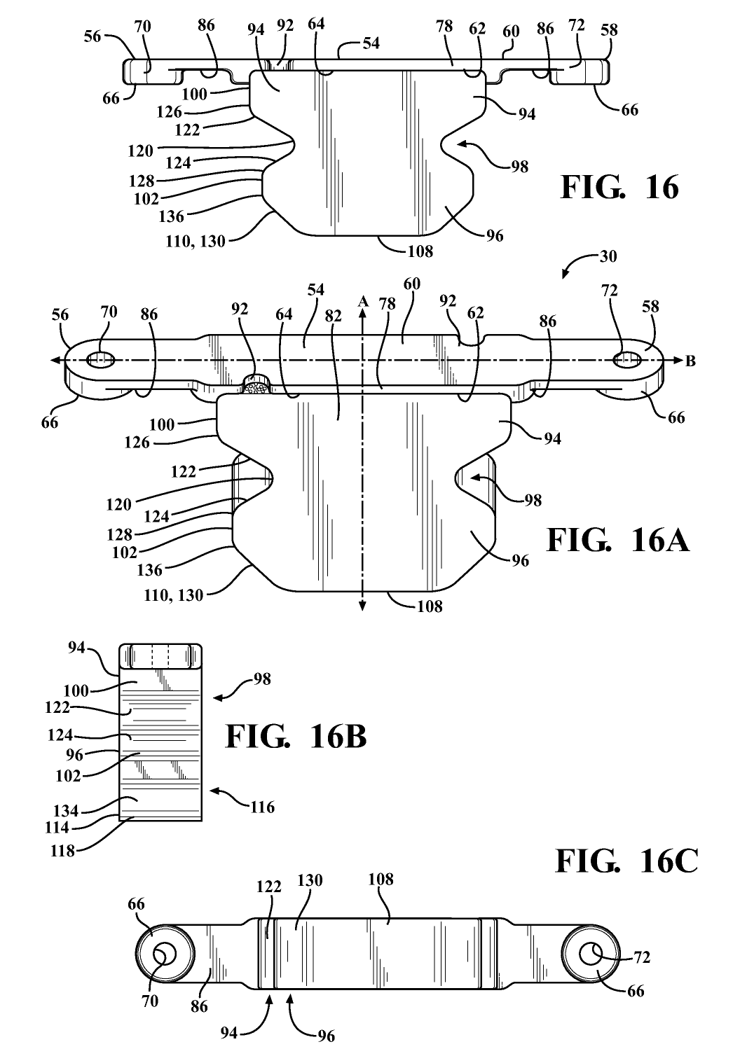

As described above, when the bumper 36 has the first bumper portion 94 and the second bumper portion 96, the second bumper portion 96 has the outermost bumper surface 108. In certain embodiments, as described above, the edge 110 of the second bumper portion 96 may be further defined as a third edge 130. As shown in FIGS. 2, 3, 6, 9-13, and 16-16C, the third edge 130 extends from the second bumper surface 102 to the outermost bumper surface 108 toward the central axis A. In some embodiments, as shown in FIG. 16, the third edge 130 extends straight with respect to the central axis A and the overmolded bracket 38. When the third edge 130 extends straight with respect to the central axis A and the overmolded bracket 38, the third edge 130 may be parallel with the first edge 122, as shown in FIG. 16.

When the bumper 36 has the first bumper portion 94, the second bumper portion 96 and the third bumper portion 114 define a second fillet 132 therebetween, as shown in FIGS. 14, 14A, 15, 15A, and 16, 16A. Specifically, the third bumper portion 114 has a fourth edge 134 extending from the third bumper surface 118 to the second fillet 132 and toward the overmolded bracket 38 along the central axis A, and the third edge 130 extends from the second bumper surface 102 to the second fillet 132 and away from the overmolded bracket 38 along the central axis A. The third edge 130 and the fourth edge 134 cooperatively define the second valley 116. In some embodiments, the third edge 130 defines half of the second valley 116 and the fourth edge 134 defines the other half of the second valley 116, as shown in FIGS. 17 and 17A. The third edge 130 and the second bumper surface 102 intersect and may form a third rounded corner 136, and the fourth edge 134 and the third bumper surface 118 may form a fourth rounded corner 138. Additionally, the third bumper portion 114 has a fifth edge extending from the third bumper surface 118 to the outermost bumper surface 108 and away from the overmolded bracket 38 along the central axis A, as shown in FIGS. 14, 14A, 15, 15A, 17, and 17A. The fifth edge 140 and the third bumper surface 118 may form a fifth rounded corner 142. The outermost bumper surface 108 and the fifth edge 140 may form a sixth rounded corner 144.

In some embodiments, the second edge 124 and the fourth edge 134 are parallel to one another, as shown in FIGS. 14, 15, and 17. The first edge 122, the third edge 130, and the fifth edge 140 may be parallel to one another, as shown in FIGS. 14, 15, and 17.

When the bumper 36 defines the valley 98 between the first bumper portion 94 and the second bumper portion 96, and the second bumper portion 96 and the third bumper portion 114 define the second valley 116, the valley 98 has a valley perimeter about the first fillet 120, and the second valley 116 has a second valley perimeter about the second fillet 132. Specifically, the valley perimeter is defined about the central axis A and parallel to the longitudinal axis B along the first fillet 120, the first bumper side 82, and the second bumper side 84 Also, the second valley perimeter is defined about the central axis A and parallel to the longitudinal axis B along the second fillet 132, the first bumper side 82, and the second bumper side 84. In some embodiments, as shown in FIGS. 14, 15, and 17, the valley perimeter is greater than the second valley perimeter. It is to be appreciated that the valley perimeter and the second valley perimeter may be equal to one another, or that the valley perimeter may be less than the second valley perimeter without departing from the nature of the present invention.

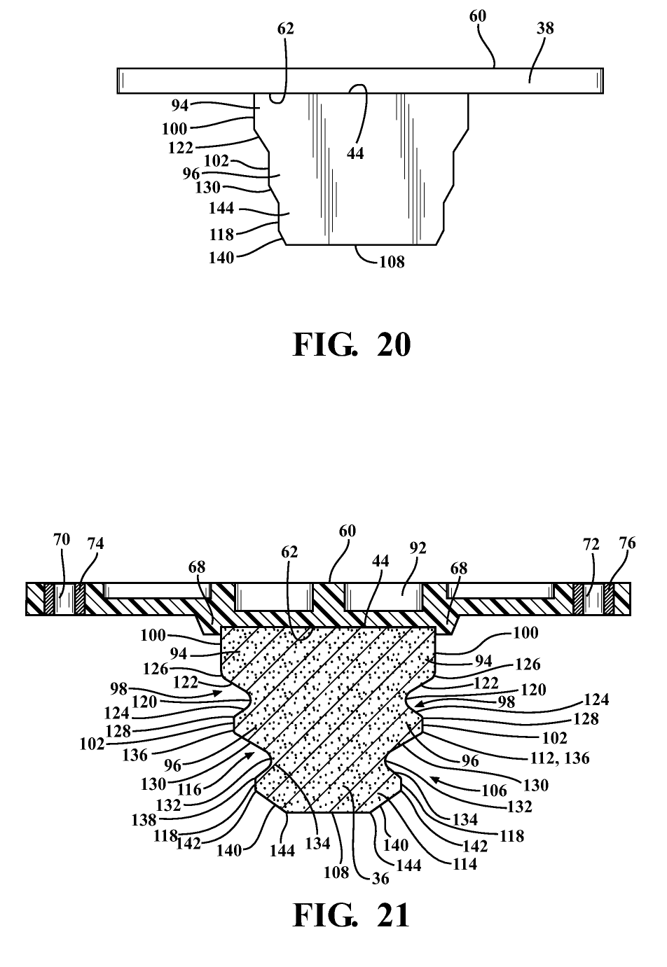

Another embodiment of the bumper 36 is shown in FIG. 20. The first edge 122, second edge 124, and third edge 130 form a stepped configuration. In other words, the first edge 122 extends from the first bumper surface 100 to the second bumper surface 102, the third edge 130 extends from second bumper surface 102 to the third bumper surface 118, and the fifth edge 140 extends from the third bumper surface 118 to the outermost bumper surface 108.

Depending on the application of the dampener assembly 30, design of the overmolded bracket 38 and the bumper 36 may change. To determine such a design, load deflection curves of the dampener assembly 30 are analyzed to determine the appropriate dimensions of the bumper 36 and the overmolded bracket 38 for each different application. For example, a width of the bumper 36 defined perpendicular to the longitudinal axis B may increase or decrease depending on the desired load deflection curve. Likewise, a length of the bumper 36 defined along the longitudinal axis B may increase or decrease depending on the load deflection curve.

Furthermore, the bumper 36 may have more than three portions and two valleys depending on the application. When the bumper 36 has multiple portions and defines valleys between the portions, the bumper 36 collapses better under a load along the central axis A. Furthermore, when the bumper 36 defines valleys between the portions, a surface area defined by the exterior of the bumper 36 decreases. When the surface area of the exterior of the bumper 36 decreases, the stiffness of the bumper 36 also decreases. Alternatively, when the surface area of the bumper 36 increases, the stiffness of the bumper 36 also increases.

It is to be appreciated that the FIGS. are schematic representations of the dampener assembly 30. As such, it is to be appreciated that the dampener assembly 30 shown throughout the FIGS. may not be to the proper size and/or scale.

While the invention has been described in an illustrative manner with reference to exemplary embodiments, it will be understood by those skilled in the art that various changes may be made and equivalents may be substituted for elements thereof without departing from the scope of the invention. The terminology which has been used is intended to be in the nature of words of description rather than of limitation. In addition, many modifications may be made to adapt a particular situation or material to the teachings of the invention without departing from the essential scope thereof. The invention may be practiced otherwise than as described. Therefore, it is intended that the invention not be limited to the particular embodiment disclosed as the best mode contemplated for carrying out this invention, but that the invention will include all embodiments falling within the scope of the appended claims.

1. A dampener assembly for dampening vibrations between a first member and a second member with at least one of the first and second members movable relative to the other one of the first and second members, said dampener assembly comprising:
a bumper comprising a cellular material defining a plurality of cells, with said bumper having a mounting surface wherein a portion of said plurality of cells are open at said mounting surface; and
an overmolded bracket comprising a polymeric material, with said overmolded bracket having a body portion extending between a first bracket end and a second bracket end, with said body portion having an attachment surface configured to couple to the first member, and a bonding surface opposite said attachment surface with said bonding surface coupled to said bumper;
wherein said polymeric material of said overmolded bracket is disposed within said open cells at said mounting surface of said bumper for bonding said overmolded bracket and said bumper to one another.

2. The dampener assembly as set forth in claim 1 wherein said polymeric material of said overmolded bracket comprises thermoplastic polyurethane.

3. The dampener assembly as set forth in claim 1 wherein said bumper comprises microcellular polyurethane.

4. The dampener assembly as set forth in claim 1 wherein said bonding surface of said overmolded bracket defines a recess with said mounting surface of said bumper bonded to said bonding surface within said recess.

5. The dampener assembly as set forth in claim 4 wherein said overmolded bracket has an end surface opposite said attachment surface at each of said first and second bracket ends, and wherein said overmolded bracket has a retaining wall extending from said bonding surface perpendicular relative to said attachment surface and beyond said end surface, with said retaining wall defining a portion of said recess thereby increasing a depth of said recess.

6. (canceled)

7. The dampener assembly as set forth in claim 1 wherein said overmolded bracket has an end surface opposite said attachment surface at each of said first and second bracket ends, and wherein said first bracket end defines a first aperture between said end surface and said attachment surface, and said second bracket end defines a second aperture between said end surface and said attachment surface.

8. The dampener assembly as set forth in claim 7 further comprising a first insert disposed in said first aperture for reinforcing said overmolded bracket at said first aperture, and a second insert disposed within said second aperture for reinforcing said overmolded bracket at said second aperture.

9. The dampener assembly as set forth in claim 1 wherein said overmolded bracket defines a longitudinal axis extending from said first bracket end to said second bracket end, with said overmolded bracket having a first bracket side and a second bracket side opposite said first bracket side along said longitudinal axis, and with said first and second bracket sides each independently defining a cutout for weight reduction of said overmolded bracket.

10. The dampener assembly as set forth in claim 1 which is free of adhesive between said mounting surface of said bumper and said bonding surface of said overmolded bracket.

11. The dampener assembly as set forth in claim 1 wherein said bumper is directly bonded to said overmolded bracket.

12. The dampener assembly as set forth in claim 1 wherein said polymeric material of said overmolded bracket is disposed within at least 20 percent of said open cells at said mounting surface for bonding said overmolded bracket and said bumper to one another.

13. The dampener assembly as set forth in claim 1 wherein said overmolded bracket defines a longitudinal axis extending from said first bracket end to said second bracket end, with said overmolded bracket having a first bracket side and a second bracket side opposite said first bracket side along said longitudinal axis, and with said bumper having first and second bumper sides each extending perpendicular relative to said attachment surface of said overmolded bracket with said first bumper side parallel to said first bracket side and said second bumper side parallel to said second bracket side.

14. The dampener assembly as set forth in claim 13 wherein said first bumper side is flush with said first bracket side and said second bumper side is flush with said second bracket side.

15. The dampener assembly as set forth in claim 1 wherein said overmolded bracket has a body surface opposite said attachment surface and disposed between said first and second bracket ends, with said overmolded bracket having a first thickness between said body surface and said attachment surface at said first and second ends, and said overmolded bracket having a second thickness between said bonding surface and said attachment surface, wherein said first thickness is equal to said second thickness.

16. (canceled)

17. The dampener assembly as set forth in claim 1 wherein said bumper has a first bumper portion bonded to said bonding surface of said overmolded bracket, and a second bumper portion extending from said first bumper portion opposite said overmolded bracket wherein said first bumper portion and said second bumper portion define a valley therebetween.

18. The dampener assembly as set forth in claim 17 wherein said bumper extends along a central axis, and wherein said overmolded bracket has an end surface opposite said attachment surface at each of said first and second bracket ends, with said bonding surface of said overmolded bracket defining a recess with said bonding surface disposed between said end surface and said attachment surface along said central axis, and with said first bumper portion partially disposed within said recess and bonded to said bonding surface of said overmolded bracket.

19. (canceled)

20. The dampener assembly as set forth in claim 17 wherein said first bumper portion is a first rectangularly shaped prism and said second bumper portion is a second rectangularly shaped prism.

21. The dampener assembly as set forth in claim 20 wherein said first rectangularly shaped prism has a first volume and said second rectangularly shaped prism has a second volume with said first volume greater than said second volume.

22. (canceled)

23. (canceled)

24. (canceled)

25. (canceled)

26. The dampener assembly as set forth in claim 17 wherein said bumper further comprises a third bumper portion extending from said second bumper portion opposite said first bumper portion with said second bumper portion and said third bumper portion defining a second valley therebetween.

27. (canceled)

28. The dampener assembly as set forth in claim 26 wherein said first bumper portion is a first rectangularly shaped prism having a first volume, said second bumper portion is a second rectangularly shaped prism having a second volume, and said third bumper portion is a third rectangularly shaped prism having a third volume, with said first volume greater than said second volume and said second volume greater than said third volume.

29. (canceled)

30. (canceled)
